(19) United States
(12) Patent Application Publication
(10) Pub. No.: US 2006/0125981 A1
(43) Pub. Date: Jun. 15, 2006

(54) Display and mobile device

(76) Inventor: Tatsumi Okuda, Motosu-shi (JP)

Correspondence Address: MCDERMOTT WILL & EMERY LLP, 600 13TH STREET, N.W., WASHINGTON, DC, 20005-3096, US

(21) Appl. No.: 11/285,385

(22) Filed: Nov. 23, 2005

(30) Foreign Application Priority Data
Nov. 26, 2004 (JP) JP2004-341351
Nov. 30, 2004 (JP) JP2004-345728

(51) Int. Cl. G02F 1/1333; G02F 1/1345

(52) U.S. Cl. 349/110; 349/149; 349/58

(57) ABSTRACT

A display is provided that can prevent light leakage from the backlight source to the display region via the inner side faces of the frame. Such a display includes: a display panel that has a display region; a frame that houses the display panel; a backlight source that is disposed on the back face side of the display panel; and a light shielding portion that is formed on the display panel and covers the regions other than the display region of the display panel. The light shielding portion includes a light leakage preventing portion that is designed to partially protrude toward a side end face of the display panel when viewed from the top, and prevents light leakage from the backlight source.

### CROSS-REFERENCE TO RELATED APPLICATIONS

The priority applications Nos. JP2004-341351 and JP2004-345728 upon which this patent application is based are hereby incorporated by reference.

### BACKGROUND OF THE INVENTION

1. Field of the Invention

The present invention relates to a display and a mobile device, and more particularly, to a display that has a display panel, and a mobile device that includes the display.

2. Description of the Background Art

There have been displays each having a display panel. An example of such displays is disclosed in Japanese Patent Publication No. 3322629. Japanese Patent Publication No. 3322629 discloses the structure of a liquid crystal display unit that has a liquid crystal display panel with lines. As a conventional liquid crystal display unit having a display panel, a structure that has a light shielding portion (a black mask) to cover the regions other than the display region such as the line patterns provided on the display panel has been known.

FIG. 29 is a perspective view of a conventional LCD unit (a display) that has a light shielding portion to cover the line pattern on the display panel. FIG. 30 is an exploded perspective view of the conventional LCD unit shown in FIG. 29. FIGS. 31 through 33 illustrate the structure of the conventional LCD unit shown in FIG. 29 in greater detail. Referring to FIGS. 29 through 33, the conventional LCD unit 240 is described.

As shown in FIG. 29, the conventional LCD unit 240 includes an upper frame 201 and a lower frame 202 that are made of metal, an upper deflecting plate 203 that is disposed inside the upper frame 201 and the lower frame 202, and a panel flexible printed circuit board (a panel FPC board) 204. A connector inserting portion 204b of the panel FPC board 204 of the LCD unit 240 is connected to a connector portion 231 of a printed circuit board 230 of a mobile phone handset.

As shown in FIG. 30, the metal lower frame 202 includes a bottom face portion 202a and four side face portions 202b that extend upward from the four sides of the bottom face portion 202a. The side face portions 202b have protruding portions 202c protruding outward. A notch portion 202d is formed in the side face portion 202b of the lower frame 202 on the side to which the panel FPC board 204 is to be attached. Further, a reflective sheet 205 is disposed above the bottom face portion 202a of the lower frame 202. A resin frame 206 having an opening 206a at the bottom is provided above the reflective sheet 205. In the resin frame 206, a FPC inserting portion 206b through which the panel FPC board 204 is to be inserted is formed at the location corresponding to the notch portion 202d of the lower frame 202. The resin frame 206 also has side walls 206c extending upward from the hems of the resin frame 206. As shown in FIGS. 30 and 31, the resin frame 206 also has concave portions 206d and convex portions 206e for positioning.

Inside the resin frame 206, a light guide plate 208 for guiding the light from light emitting diodes (LEDs) 207 (see FIG. 32) to the entire panel, and lens sheets 209 and 210 are stacked in this order from the bottom, as shown in FIGS. 32 and 33. As shown in FIGS. 30 and 31, positioning portions 209a and 210a that are convexities when seen from the top are formed on the side end faces of the lens sheets 209 and 210. The lens sheets 209 and 210 transmit light to the above from the light guide plate 208, and also concentrate the light. As shown in FIGS. 32 and 33, a diffusion sheet 211 is provided above the lens sheets 209 and 210. This diffusion sheet 211 transmits light to the above from the lens sheets 209 and 210, and also diffuses the light. As shown in FIG. 32, a backlight flexible printed circuit board (a backlight FPC board) 212 is bonded to the upper face of the light guide plate 208 with two-sided tape (not shown). The backlight FPC board 212 has an external connecting portion that protrudes outward from the FPC inserting portion 206b of the resin frame 206. A connector inserting portion 212a (see FIG. 30) is formed at the top end portion of the external connecting portion. The backlight FPC board 212 also has the LEDs 207 that emit light onto the light guide plate 208. The LEDs 207 are disposed in such a manner as to emit light toward the light guide plate 208.

As shown in FIG. 30, a black adhesive layer 213 having an opening 213a is bonded to the peripheral portion along the hems of the upper face of the diffusion sheet 211. This adhesive layer 213 is provided to cover the peripheral portions of the hems of the lens sheets 209 and 210, and functions to block the light traveling upward from the peripheral portions of the hems of the lens sheets 209 and 210. The diffusion sheet 211 and the adhesive layer 213 are positioned by the convex portions 206e of the resin frame 206. As shown in FIG. 33, a predetermined distance D1 is maintained between the convex portions 206e on the side walls 206c of the resin frame 206 and the diffusion sheet 211 and the adhesive layer 213, so that the diffusion sheet 211 and the adhesive layer 213 are prevented from bending due to measurement errors (size variations) of the diffusion sheet 211 and the adhesive layer 213 when the diffusion sheet 211 and the adhesive layer 213 are set to the resin frame 206.

As shown in FIGS. 32 and 33, a lower deflecting plate 214 is disposed above the diffusion sheet 211 and the adhesive layer 213. Further, a lower glass substrate 215 and an upper glass substrate 216 that are arranged to interpose liquid crystal are provided above the lower deflecting plate 214. Although not shown, a thin-film transistor is formed on the lower glass substrate 215. The glass substrates 215 and 216 including the liquid crystal and the thin-film transistor constitute a display panel. The display panel formed with the glass substrates 215 and 216 is positioned by the convex portions 206e of the resin frame 206. A black light shielding portion 217 to cover the regions other than the display region such as the line pattern formed on the glass substrates 215 and 216 is formed on the glass substrates 215 and 216. As shown in FIG. 31, the light shielding portion 217 is designed to surround the display region along the peripheral portions of the hems of the glass substrates 215 and 216. As shown in FIG. 32, the lower glass substrate 215 has a protruding portion 215a protruding from the upper glass substrate 216 toward the FPC inserting portion 206b of the resin frame 206. The upper deflecting plate 203 is disposed on the upper glass substrate 216.

Further, a driver IC (integrated circuit) 218 for driving the display panel and the panel FPC board 204 are mounted onto the upper face of the protruding portion 215a of the lower glass substrate 215. The panel FPC board 204 is electrically connected to the driver IC 208.

As shown in FIGS. 29 and 31, an electronic component attaching portion 204a to which electronic components 219 are to be attached is formed at the outward protruding portion of the panel FPC board 204. As shown in FIG. 29, a connector portion 220 to which the connector inserting portion 212a (see FIG. 30) of the backlight FPC board 212 is to be connected is also attached to the electronic component attaching portion 204a. Further, the connector inserting portion 204b is formed at the end of the electronic component attaching portion 204a.

As shown in FIG. 30, the metal upper frame 201 is disposed above the upper deflecting plate 203. The upper frame 201 includes an upper face portion 201b having an opening 201a, and four side face portions 201c that extend downward from the four sides of the upper face portion 201b. The opening 201a of the upper frame 201 is formed in the area corresponding to the display region of the glass substrates 215 and 216. Further, insertion holes 201d through which protruding portions 202c of the lower frame 202 are to be inserted are formed in the side face portions 201c of the upper frame 201. A notch portion 201e is also formed at the location of the side face portion 201c corresponding to the notch portion 202d of the lower frame 202. By virtue of the opening formed with the notch portion 202d of the lower frame 202 and the notch portion 201e of the upper frame 201, the panel FPC board 204 and the backlight FPC board 212 are designed to protrude outward, as shown in FIG. 29.

In the conventional LCD unit 240 illustrated in FIGS. 29 through 33, the light emitted from the LEDs 207 is introduced to the convex positioning portions 209a and 210a of the lens sheets 209 and 210 via the light guide plate 208. As the light introduced to the convex positioning portions 209a and 210a of the lens sheets 209 and 210 travels in the direction of the arrow C of FIG. 33, light leakage is caused between the black adhesive layer 213 and the inner faces of the side walls 206c of the resin frame 206. As a result, the light travels in the direction of the arrow D of FIG. 33, from the vicinity of the concave portions 206d of the resin frame 206. This causes the problem of light leakage from the outside of the light shielding portion 217 mounted to the glass substrates 215 and 216 toward the opening portion 201a (the display region) of the upper frame 201.

In the conventional LCD unit 240 illustrated in FIGS. 29 through 33, the driver IC 218 is not mounted to the panel FPC board 204, but is mounted to the surface of the glass substrate 215 that constitutes the display panel. Accordingly, it is possible to reduce the size of the panel FPC board 204. However, the backlight FPC board 212, the diffusion sheet 211, and the glass substrate 215, which are interposed between the LEDs 207 and the driver IC 218, are made of light transmissive materials. This causes the problem that the light emitted from the LEDs 207 to the light guide plate 208 is partially reflected in the direction of the arrow A (see FIG. 32) by the side faces 208a of the light guide plate 208, and enters the driver IC 218, resulting in an operation error of the driver IC 218 due to the light from the LEDs 207.

### SUMMARY OF THE INVENTION

A general object of the present invention is to eliminate the above disadvantages.

A more specific object of the present invention is to provide a display and a mobile device that can prevent light leakage from the backlight source toward the display region via the inner side faces of a frame.

Another specific object of the present invention is to provide a display and a mobile device that can have a smaller flexible printed circuit (FPC) board, and can prevent a wrong operation of the first electronic component.

So as to achieve the above objects, a display in accordance with a first aspect of the present invention includes: a display panel that has a display region; a frame that houses the display panel; a backlight source that is disposed on the back face side of the display panel; and a light shielding portion that is disposed on the display panel and covers the regions other than the display region of the display panel. Here, the light shielding portion includes a light leakage preventing portion that is designed to partially protrude toward a side end face of the display panel when viewed from the top, and prevents light leakage from the backlight source.

As described above, in the display in accordance with the first aspect of the present invention, the light shielding portion covering the regions other than the display region of the display panel has the light leakage preventing portion that is designed to partially protrude toward a side end face of the display panel and prevents light leakage from the backlight source. By virtue of the light leakage preventing portion, the light leaking from the backlight source toward the display region via the side end faces of the display panel (or the inner side faces of the frame) can be blocked. Thus, the light from the backlight source can be prevented from leaking toward the display region via the inner side faces of the frame.

A mobile device in accordance with a second aspect of the present invention includes the display in accordance with the first aspect. Thus, a mobile device having a display that can prevent light leakage from the backlight source toward the display region via the inner side faces of the frame can be obtained.

A display in accordance with a third aspect of the present invention includes: a display panel; a first electronic component that is attached to the display panel; a backlight source that is disposed on a back face of the display panel; and a light shielding member that is provided to prevent light of the backlight source from entering the first electronic component.

As described above, in the display in accordance with the third aspect of the present invention, the light of the backlight source can be prevented from entering the first electronic component by the light shielding member that is provided to block the light of the backlight source traveling into the first electronic component. Thus, the first electronic component can be prevented from wrongly operate due to the light from the backlight source. Also, as the first electronic component is attached to the display panel, the flexible printed circuit (FPC) board can be made smaller than in a case where the first electronic component is mounted to the flexible printed circuit board.

A mobile device in accordance with a fourth aspect of the present invention includes the display in accordance with the third aspect. Thus, a mobile device having a display that has a smaller flexible printed circuit board and prevents an error operation of the first electronic component can be obtained.

### BRIEF DESCRIPTION OF THE DRAWINGS

FIG. 1 is a perspective view of the entire structure of a LCD unit in accordance with a first embodiment of the present invention;

FIG. 2 is a side view of the LCD unit in accordance with the first embodiment shown in FIG. 1, where the LCD unit is mounted to the printed circuit board of a mobile phone handset;

FIG. 3 is an exploded perspective view of the LCD unit in accordance with the first embodiment shown in FIG. 1;

FIG. 4 is a plan view of the resin frame, the lens sheets, and the display panel of the LCD unit in accordance with the first embodiment shown in FIG. 1;

FIG. 5 is a cross-sectional view of the LCD unit, taken along the line 100-100 of FIG. 4;

FIG. 6 is a cross-sectional view of the LCD unit, taken along the line 200-200 of FIG. 4;

FIG. 7 is a perspective view of the LCD unit in accordance with the first embodiment shown in FIG. 1, where the lens sheets are housed in the resin frame;

FIG. 8 is a plan view illustrating a method of manufacturing the display panel of the LCD unit in accordance with the first embodiment shown in FIG. 1;

FIG. 9 is a plan view of the display panel and the resin frame of a LCD unit in accordance with a second embodiment of the present invention;

FIG. 10 is a cross-sectional view of the LCD unit, taken along the line 300-300 of FIG. 9;

FIG. 11 is a perspective view of a LCD unit having a display panel in accordance with a third embodiment of the present invention;

FIG. 12 is a side view of the LCD unit in accordance with the third embodiment shown in FIG. 11, where the LCD unit is mounted to a substrate;

FIG. 13 is a cross-sectional perspective view of the LCD unit, taken along the line 400-400 of FIG. 11;

FIG. 14 is a cross-sectional view of the LCD unit in accordance with the third embodiment shown in FIG. 11, where the LCD unit is mounted in a mobile phone handset;

FIG. 15 is an exploded perspective view of the LCD unit in accordance with the third embodiment shown in FIG. 11;

FIG. 16 is a detailed perspective view of the structure of the resin frame of the LCD unit in accordance with the third embodiment shown in FIG. 11;

FIG. 17 is a detailed perspective view of the structure of the backlight FPC board of the LCD unit in accordance with the third embodiment shown in FIG. 11;

FIG. 18 is a detailed perspective view of the structure of the glass substrates of the LCD unit in accordance with the third embodiment shown in FIG. 11;

FIG. 19 is a detailed perspective view of the structure of the upper frame of the LCD unit in accordance with the third embodiment shown in FIG. 11;

FIG. 20 is a cross-sectional view of the LCD unit in accordance with the third embodiment shown in FIG. 11, where a touch panel is disposed on the upper frame;

FIG. 21 is a perspective view of a LCD unit in accordance with a first modification of the present invention, where the LCD unit is mounted to the printed circuit board of a mobile phone handset;

FIG. 22 is a side view of the LCD unit in accordance with the first modification of the present invention shown in FIG. 21, where the LCD unit is mounted to the printed circuit board of a mobile phone handset;

FIG. 23 is a perspective view of a LCD unit in accordance with a second modification of the present invention, where the LCD unit is mounted to the printed circuit board of a mobile phone handset;

FIG. 24 is a side view of the LCD unit in accordance with the second modification of the present invention shown in FIG. 23, where the LCD unit is mounted to the printed circuit board of a mobile phone handset;

FIG. 25 is a perspective view of the LCD unit in accordance with a third modification of the present invention, where the LCD unit is mounted to the printed circuit board of a mobile phone handset;

FIG. 26 is a side view of the LCD unit in accordance with the third modification of the present invention shown in FIG. 25, where the LCD unit is mounted to the printed circuit board of a mobile phone handset;

FIG. 27 is a cross-sectional perspective view of a LCD unit in accordance with a fourth modification of the present invention;

FIG. 28 is a cross-sectional view of the LCD unit in accordance with the fourth modification of the present invention, where the LCD unit is mounted in a chassis of a mobile phone handset;

FIG. 29 is a perspective view of the entire structure of a conventional LCD unit;

FIG. 30 is an exploded perspective view of the conventional LCD unit shown in FIG. 29;

FIG. 31 is a plan view of the resin frame, the lens sheets, and the display panel of the conventional LCD unit shown in FIG. 29;

FIG. 32 is a cross-sectional perspective view of the conventional LCD unit, taken along the line 500-500 of FIG. 31; and

FIG. 33 is a cross-sectional perspective view of the conventional LCD unit, taken along the line 600-600 of FIG. 31.

### DETAILED DESCRIPTION OF THE PREFERRED EMBODIMENTS

The following is a description of embodiments of the present invention, with reference to the accompanying drawings.

### First Embodiment

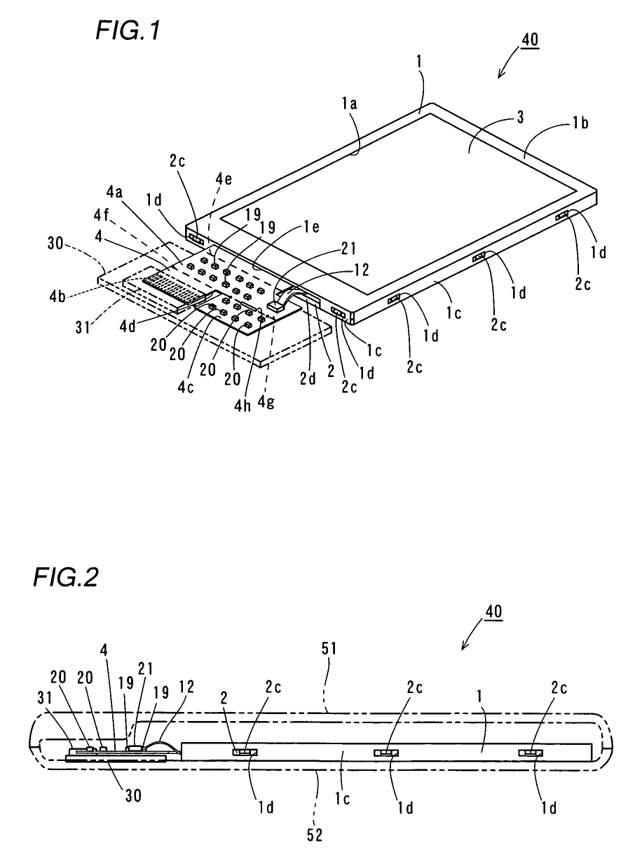

Referring first to FIGS. 1 through 7, the structure of a LCD unit 40 in accordance with a first embodiment of the present invention is described. In the first embodiment, the LCD unit 40 is described as an example of the “display” in the claims.

As shown in FIGS. 1 and 2, the LCD unit 40 in accordance with the first embodiment includes an upper frame 1 and a lower frame 2 that are formed with metal plates, an upper deflecting plate 3 (see FIG. 1) that is disposed inside the upper frame 1 and the lower frame 2, and a panel flexible printed circuit board (panel FPC board) 4. The panel FPC board 4 is an example of the “flexible printed circuit board” in the claims. As shown in FIG. 2, the LCD unit 40 is housed in an upper chassis 51 and a lower chassis 52 of a mobile phone handset. Also, a connector inserting portion 4b (see FIG. 1) of the panel FPC board 4 of the LCD unit 40 is connected to a connector portion 31 of a printed circuit board 30 of the mobile phone handset.

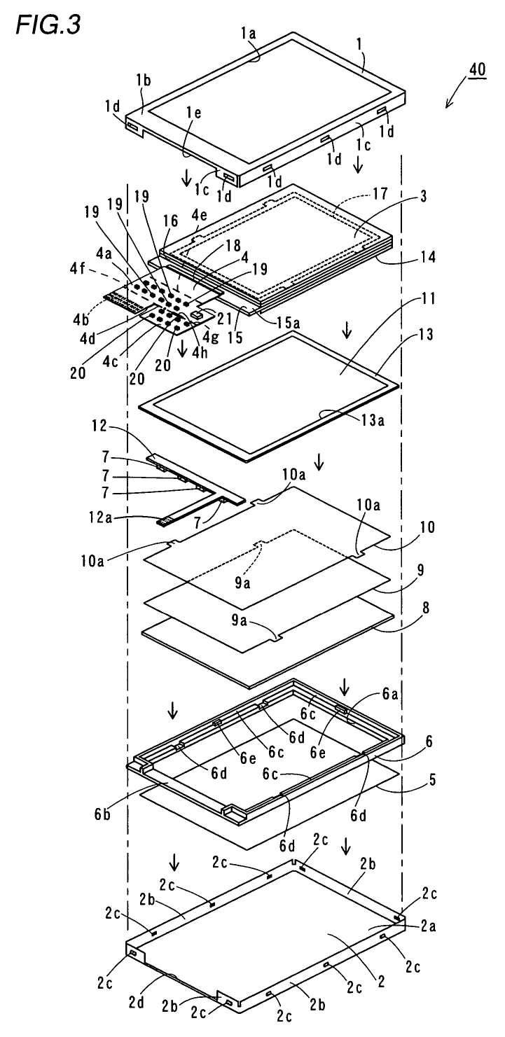

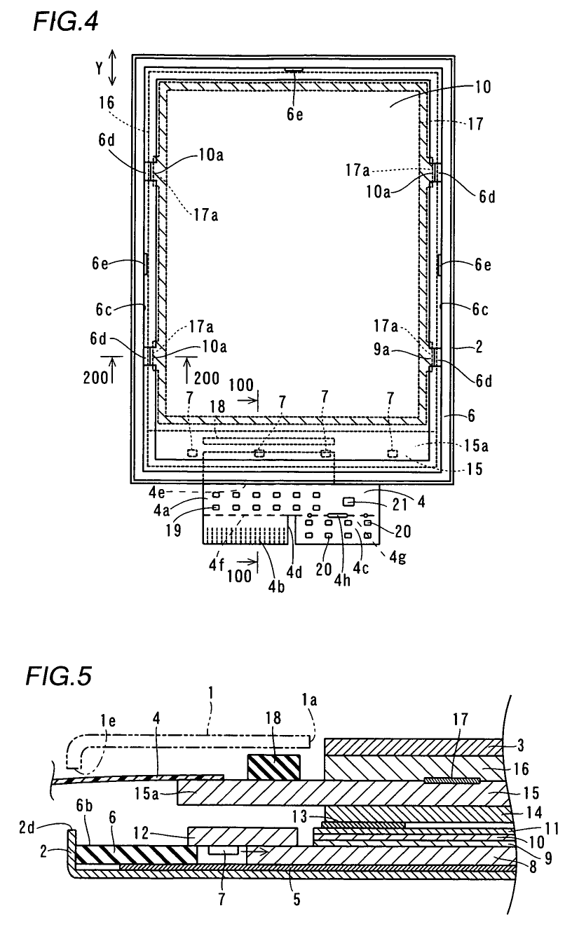

As shown in FIG. 3, the lower frame 2 made of metal includes a bottom face portion 2a and four side face portions 2b that extend upward from the four sides of the bottom face portion 2a. Each of the side face portions 2b has protruding portions 2c extending outward. A notch portion 2d is formed in the side face portion 2b on the side at which the panel FPC board 4 is to be disposed. A reflective sheet 5 is disposed over the bottom face portion 2a of the lower frame 2. A resin frame 6 having an opening 6a at the bottom is further disposed on the reflective sheet 5. The resin frame 6 is an example of the “frame” in the claims. The resin frame 6 also has a FPC inserting portion 6b through which the panel FPC board 4 is to be inserted at the portion corresponding to the notch portion 2d of the lower frame 2. The resin frame 6 further has side walls 6c extending upward from the hems of the resin frame 6. As shown in FIGS. 3 and 4, the resin frame 6 also has concave portions 6d (four of them in the first embodiment) for positioning and convex portions 6e (three of them in the first embodiment).

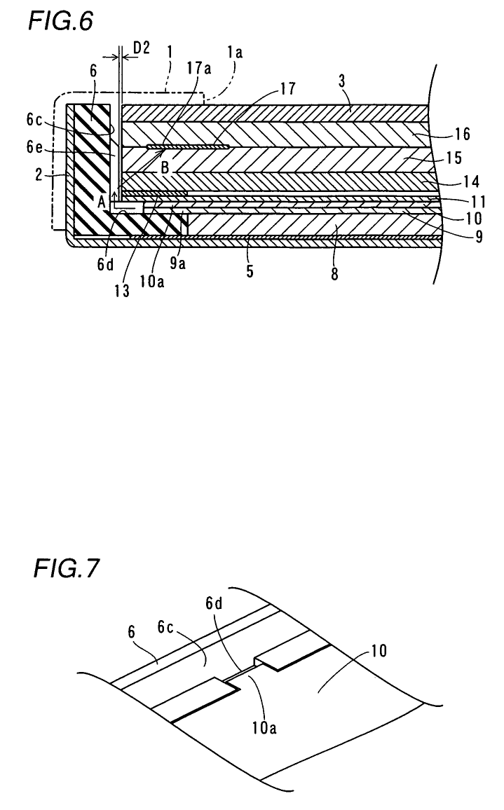

Inside the resin frame 6, a light guide plate 8 for guiding light from LEDs 7 (see FIG. 5) to the entire panel and lens sheets 9 and 10 are disposed in this order from the bottom, as shown in FIGS. 5 and 6. Positioning portions 9a and 1a that are convex portions when viewed from the top are formed on side end faces of the lens sheets 9 and 10, as shown in FIGS. 3 and 4. The lens sheets 9 and 10 transmit light upward from the light guiding plate 8, and have the function of gathering light. Also, a diffusion sheet 11 is disposed over the lens sheet 10, as shown in FIGS. 5 and 6. The diffusion sheet 11 transmits light upward from the lens sheets 9 and 10, and has the function of diffusing light. As shown in FIG. 5, a backlight flexible printed circuit board (backlight FPC board) 12 is attached onto the upper face of the light guide plate 8 with two-sided tape (not shown). The backlight FPC board 12 has an external connecting portion that extends outward from the FPC inserting portion 6b of the resin frame 6. A connector inserting portion 12a (see FIG. 3) is provided at the edge of the external connecting portion. The backlight FPC board 12 also has LEDs 7 (four of them in the first embodiment) that emit light onto the light guide plate 8. The four LEDs 7 are disposed so as to emit light toward the light guide plate 8. The LEDs 7 are an example of the “backlight source” in the claims.

As shown in FIG. 3, a black adhesive layer 13 having an opening 13a is bonded to the peripheral region along the upper hems of the diffusion sheet 11. This adhesive layer 13 is designed to cover the peripheral region at the hems of the lens sheets 9 and 10, and has the function of blocking the light that is heading upward from the peripheral region at the hems of the lens sheets 9 and 10. The diffusion sheet 11 and the adhesive layer 13 are positioned by the convex portions 6e of the resin frame 6. As shown in FIG. 6, a predetermined space D2 is allowed between the convex portion 6e of each side wall 6c of the resin frame 6 and the diffusion sheet 11 and the adhesive layer 13, so as to prevent the diffusion sheet 11 and the adhesive layer 13 from bending due to measurement errors (size variations) of the diffusion sheet 11 and the adhesive layer 13 when the diffusion sheet 11 and the adhesive layer 13 are set to the resin frame 6.

As shown in FIGS. 5 and 6, a lower deflecting plate 14 is disposed over the diffusion sheet 11 and the adhesive layer 13. A lower glass substrate 15 and an upper glass substrate 16 that has liquid crystal interposed between them are disposed over the lower deflecting plate 14. A thin-film transistor (not shown) is formed on the lower glass substrate 15. The glass substrates 15 and 16, together with the liquid crystal and the thin-film transistor, constitute a display panel. The display panel formed with the glass substrates 15 and 16 are positioned by the convex portions 6e of the resin frame 6.

As shown in FIGS. 3 and 4, the glass substrates 15 and 16 also have a black light shielding portion 17 that covers the regions such as the line patterns formed on the glass substrates 15 and 16, except for the display region. The light shielding portion 17 is designed to surround the display region along the peripheral region located on the hems of the glass substrates 15 and 16.

In the first embodiment, the light shielding portion 17 includes four light leakage preventing portions 17a that are convex portions partially protruding toward the side end faces of the glass substrates 15 and 16, when viewed from the top. The four light leakage preventing portions 17a are disposed at the locations corresponding to the four concave portions 6d of the resin frame 6 that are provided for positioning the convex positioning portions 9a and 10a of the lens sheets 9 and 10. As shown in FIG. 6, each of the light leakage preventing portions 17a does not reach the corresponding side end faces of the glass substrates 15 and 16, but extends to the point where a predetermined distance is kept from the glass substrates 15 and 16. Each of the light leakage preventing portions 17a also has a greater Y-direction width than the Y-direction width of each concave portion 6d of the resin frame 6 as shown in FIG. 4. With this arrangement, light can be easily shielded by the light leakage preventing portions 17a that are wider than the concave portions 6d of the resin frame 6, even where the light being guided from the LEDs 7 to the concave portions 6d of the resin frame 6 is heading toward the display region while spreading.

As shown in FIG. 5, the lower glass substrate 15 has a protruding portion 15a that protrudes from the upper glass substrate 16 toward the FPC inserting portion 6b of the resin frame 6. The upper deflecting plate 3 is also disposed over the area corresponding to the display region of the glass substrates 15 and 16. A driver IC 18 for driving the display panel and the panel FPC board 4 are attached onto the upper face of the protruding portion 15a of the lower glass substrate 15. The panel FPC board 4 is electrically connected to the driver IC 18.

In the first embodiment, the panel FPC board 4 has an electronic component attaching portion 4a to which electronic components 19 are to be attached, the connector inserting portion 4b, and an electronic component attaching portion 4c to which electronic components 20 are to be attached, as shown in FIG. 3. A connector portion 21 to which the connector inserting portion 12a (see FIG. 3) of the backlight FPC board 12 is to be connected is also attached to the electronic component attaching portion 4a. The connector inserting portion 4b is connected to the connector portion 31 of the printed circuit board 30 of the mobile phone handset. Further, a slit 4d is formed between the connector inserting portion 4b and the electronic component attaching portion 4c of the panel FPC board 4, so that the connector inserting portion 4b and the electronic component attaching portion 4c can be bent independently of each other. The electronic component attaching portion 4a is an example of the “first electronic component attaching portion” in the claims, and the electronic component attaching portion 4c is an example of the “second electronic component attaching portion” in the claims.

In this embodiment, the panel FPC board 4 further includes a bending portion 4e formed on the side of the glass substrate 15, a bending portion 4f formed between the electronic component attaching portion 4a and the connector inserting portion 4b, and a bending portion 4g formed between the electronic component attaching portion 4a and the electronic component attaching portion 4c. The bending portion 4g has a bending hole 4h that is formed to facilitate the bending at the bending portion 4g. The bending portion 4e is an example of the “first bending portion” in the claims, the bending portion 4f is an example of the “second bending portion” in the claims, and the bending portion 4g is an example of the “third bending portion” in the claims.

As shown in FIG. 3, the upper frame 1 made of metal is disposed on the upper deflecting plate 3. The upper frame 1 includes an upper face portion 1b having an opening 1a, and four side face portions 1c that extend downward from the four sides of the upper face portion 1b. The opening 1a of the upper frame 1 is formed in the area corresponding to the display region of the glass substrates 15 and 16. Further, insertion holes id through which the protruding portions 2c of the lower frame 2 are to be inserted are formed in the side face portions 1c of the upper frame 1. Also, in the side face portions 1C, a notch portion 1e is formed at the location corresponding to the notch portion 2d of the lower frame 2.

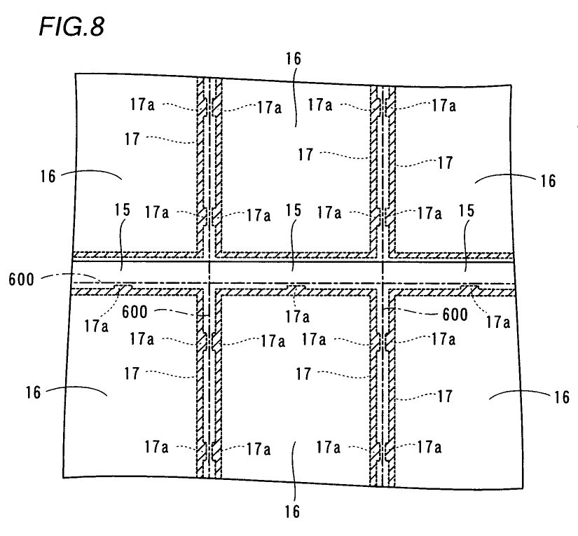

FIG. 8 is a plan view illustrating the method of manufacturing the display panel of the LCD unit 40 in accordance with the first embodiment of the present invention shown in FIG. 1. Referring now to FIG. 8, the method of manufacturing the display panel of the LCD unit 40 in accordance with the first embodiment of the present invention is described. As shown in FIG. 8, display panels formed with the glass substrates 15 and 16 are produced by dividing a large-sized panel along section lines 600. The light leakage preventing portions 17a that are made of metal or the like are designed not to reach the section lines 600 along which the dividing is performed, and extend to points where a predetermined distance is kept from the section lines 600.

In the first embodiment, each light shielding portion 17 that covers the regions other than the display region on the display panel formed with the glass substrates 15 and 16 has the light leakage preventing portions 17a for preventing light leakage from the LEDs 7. The light leakage preventing portions 17a are disposed so as to partially protrude toward side end faces of the glass substrates 15 and 16, when viewed from the top. By virtue of the light leakage preventing portions 17a, light can be easily shielded from leaking from the LEDs 7 toward the display region via the side end faces of the glass substrates 15 and 16 (or the inner side faces of the side walls 6c of the resin frame 6). Accordingly, the light from the LEDs 7 can be prevented from leaking toward the display region via the inner side faces of the side walls 6c of the resin frame 6.

Also in the first embodiment, the positioning portions 9a and 10a that are convexities when viewed from the top are formed on the side end faces of the lens sheets 9 and 10, and the resin frame 6 has concave portions 6d for positioning the convex positioning portions 9a and 10a of the lens sheets 9 and 10. The light leakage preventing portions 17a of the light shielding portion 17 are then disposed at the locations corresponding to the concave portions 6d of the resin frame 6. Accordingly, the light leakage preventing portions 17a can more easily shield the light leaking in the arrow B direction shown in FIG. 6 toward the display region via the concave portions 6d of the resin frame 6. The light leakage is caused by the light being guided in the arrow A direction shown in FIG. 6 from the LEDs 7 to the positioning portions 9a and 10a of the lens sheets 9 and 10.

Also in the first embodiment, the light leakage preventing portions 17a of the light shielding portion 17 are designed not to reach the side end faces of the glass substrates 15 and 16 but to extend to the point where the predetermined distance is kept from the side end faces of the glass substrates 15 and 16. Accordingly, the large-sized panel shown in FIG. 8 can be easily divided to form display panels, as the light leakage preventing portions 17a made of metal or the like do not exist on the section lines. Even with the light leakage preventing portions 17a, the process of forming display panels does not become complicated, and thus, display panels can be easily formed.

### Second Embodiment

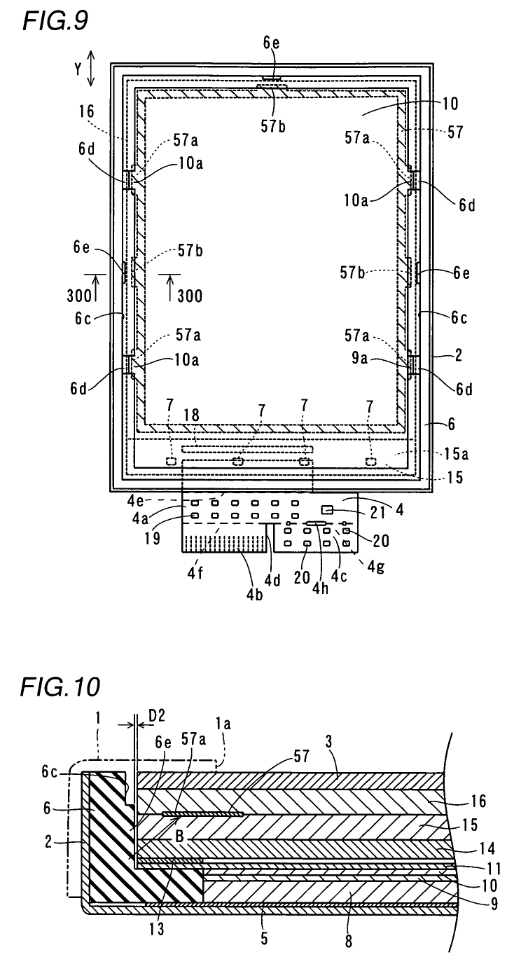

FIG. 9 is a plan view of the display panel and the resin frame of a LCD unit in accordance with a second embodiment of the present invention. FIG. 10 is a cross-sectional view of the LCD unit, taken along the line 300-300 of FIG. 9. In the second embodiment, being different from the first embodiment, the light leakage preventing portions of the light shielding portion are provided at the locations corresponding not only to the concave portions but also to the convex portions of the resin frame, as shown in FIGS. 9 and 10. The structure of the second embodiment is the same as the structure of the first embodiment, except for the light shielding portion. Therefore, explanation of the other aspects of the structure is omitted in the following description.

As shown in FIG. 9, in the LCD unit in accordance with the second embodiment, a black light shielding portion 57 to cover the regions such as line patterns other than the display region of the glass substrates 15 and 16 is formed between the glass substrates 15 and 16. Also, the light shielding portion 57 is provided along the peripheral region on the hems of the glass substrates 15 and 16.

In the second embodiment, in addition to light leakage preventing portions 57a that are disposed at the locations corresponding to the concave portions 6d of the resin frame 6, the light shielding portion 57 has light leakage preventing portions 57b disposed at the locations corresponding to the convex portions 6e of the resin frame 6 for positioning the side end faces of the display panel. As shown in FIG. 9, the light leakage preventing portions 57a and 57b are designed to partially protrude toward the side end faces of the glass substrates 15 and 16 when viewed from the top. As shown in FIG. 10, the light leakage preventing portions 57b do not reach the side end faces of the glass substrates 15 and 16, but extend to the points where a predetermined distance is kept from each side end face of the glass substrates 15 and 16. As shown in FIG. 9, each of the light leakage preventing portions 57b has a greater Y-direction width than the Y-direction width of each convex portion 6e of the resin frame 6. With this arrangement, light can be easily shielded by the light leakage preventing portions 57b that are wider than the convex portions 6e of the resin frame 6, even where the light being guided from the LEDs 7 to the convex portions 6e of the resin frame 6 is heading toward the display region while spreading.

As described above, since the convex portions 6e for positioning the side end faces of the glass substrates 15 and 16 are formed on the resin frame 6, and the light leakage preventing portions 57b are disposed at the locations corresponding to the convex portions 6e of the resin frame 6, the light leakage preventing portions 57b of the light shielding portion 57 can easily prevent light from leaking from the LEDs 7 to the display region via the convex portions 6e of the resin frame 6 in the second embodiment. Also, being disposed at the locations corresponding to the concave portions 6d and the convex portions 6e of the resin frame 6, the light leakage preventing portions 57a and 57b of the light shielding portion 57 can easily prevent light from leaking from the LEDs 7 to the display region via the convex portions 6e as well as the concave portions 6d of the resin frame 6.

### Third Embodiment

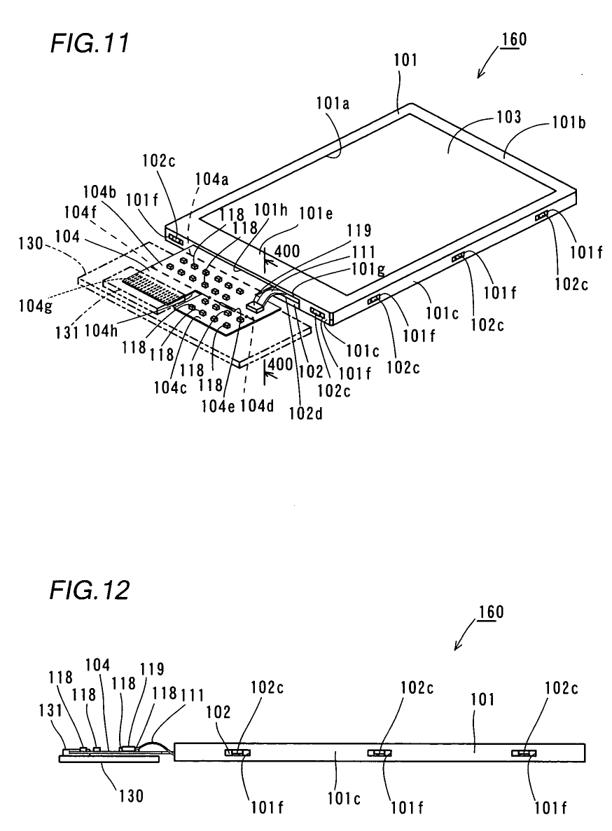

Referring now to FIGS. 11 through 20, the structure of a LCD unit 160 in accordance with a third embodiment of the present invention is described.

As shown in FIGS. 11 and 12, the LCD unit 160 in accordance with the third embodiment of the present invention includes an upper frame 101 and a lower frame 102 that are formed with metal plates, an upper deflecting plate 103 (see FIG. 11) that is disposed inside the upper frame 101 and the lower frame 102, and a panel flexible printed circuit board (panel FPC board) 104. The upper frame 101 is an example of the “frame” in the claims. The panel FPC board 104 is an example of the “flexible printed circuit board” in the claims.

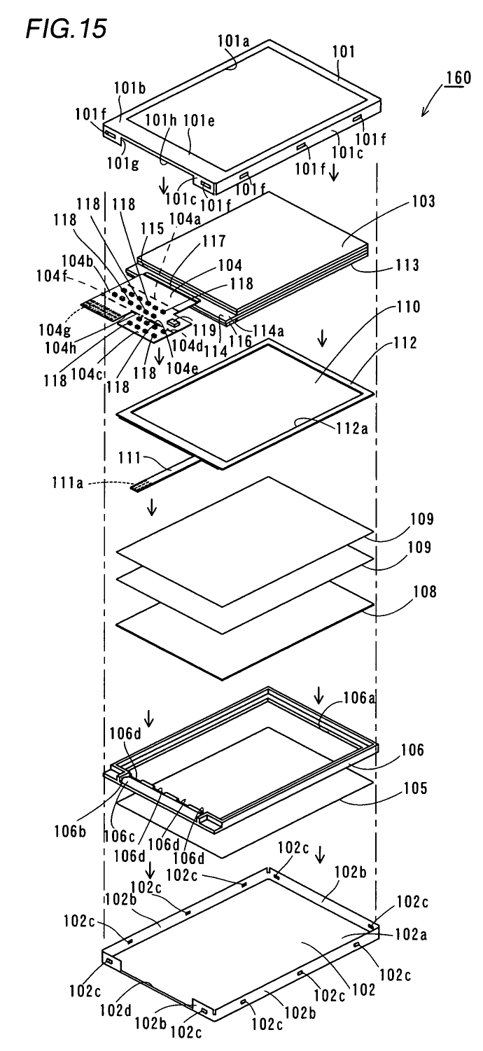

As shown in FIG. 15, the lower frame 102 made of metal includes a bottom face portion 102a and four side face portions 102b that extend upward from the four sides of the bottom face portion 102a. Each of the side face portions 102b of the lower frame 102 has protruding portions 102c extending outward. A notch portion 102d is formed in the side face portion 102b on the side at which the panel FPC board 104 is to be disposed. A reflective sheet 105 is disposed over the bottom face portion 102a of the lower frame 102. A resin frame 106 having an opening 106a at the bottom is further disposed on the reflective sheet 105. The resin frame 106 also has a FPC inserting portion 106b through which the panel FPC board 104 is to be inserted at the portion corresponding to the notch portion 102d of the lower frame 102.

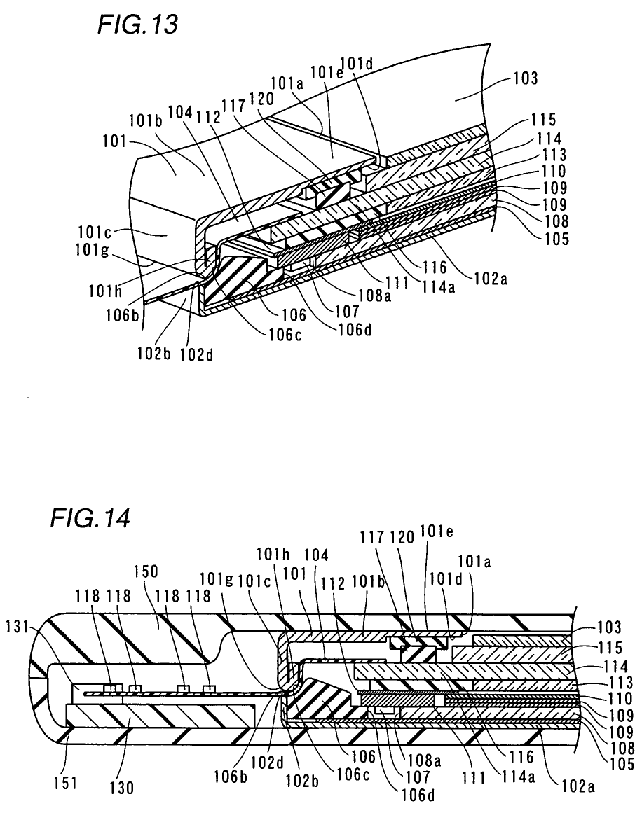

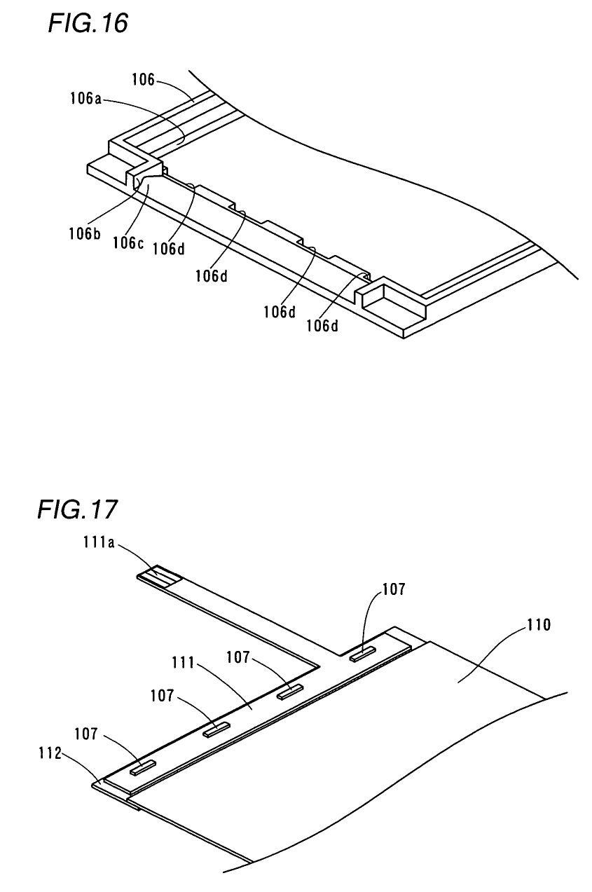

As shown in FIGS. 13, 14, and 16, an arc-like guide face 106c along which the lower face of the panel FPC board 104 (see FIGS. 13 and 14) extends is formed at the FPC inserting portion 106b of the resin frame 106. The guide face 106c is an example of the “second guide portion” in the claims. As shown in FIG. 16, concave portions 106d (four of them in the third embodiment) for accommodating LEDs 107 as backlight sources are formed at the opening 106a side of the FPC inserting portion 106b of the resin frame 106.

Inside the resin frame 106, a light guide plate 108 for guiding light from the LEDs 107 to the entire panel and two lens sheets 109 are disposed in this order from the bottom, as shown in FIG. 15. The light guide plate 108 is designed to face the LEDs 107 in the horizontal direction, and has a side face 108a through which light from the LEDs 107 enters, as shown in FIGS. 13 and 14. The lens sheets 109 transmit light upward from the light guiding plate 108, and have the function of gathering light. Also, a diffusion sheet 110 is disposed over the lens sheets 109. The diffusion sheet 110 transmits light upward from the lens sheets 109, and has the function of diffusing light. Further, a backlight flexible printed circuit board (backlight FPC board) 111 is attached to the lower face (the back face) of part of the diffusion sheet 110. The backlight FPC board 111 has an external connecting portion that extends outward from the FPC inserting portion 106b of the resin frame 106, as shown in FIG. 15. Also, a connector inserting portion 111a is provided at the edge of the external connecting portion. The backlight FPC board 111 also has the LEDs 107 (four of them in the third embodiment) that function as backlight sources placed at predetermined intervals, as shown in FIG. 17.

As shown in FIGS. 13 and 14, the four LEDs 107 are accommodated by the four concave portions 106d of the resin frame 106. The four LEDs 107 are also disposed so as to emit light toward the light guide plate 108. As shown in FIG. 15, an adhesive layer 112 having an opening 112a is bonded to the peripheral region along the upper hems of the diffusion sheet 110. Furthermore, a lower deflecting plate 113 is disposed over the adhesive layer 112. The lower deflecting plate 113 is an example of the “deflecting plate” in the claims. As shown in FIGS. 13, 14, and 18, a lower glass substrate 114 and an upper glass substrate 115 that has liquid crystal interposed between them are disposed over the lower deflecting plate 113. The glass substrate 114 is an example of the “lower glass substrate” in the claims, and the glass substrate 115 is an example of the “upper glass substrate” in the claims. A thin-film transistor (not shown) is formed on the lower glass substrate 114. The glass substrates 114 and 115, together with the liquid crystal and the thin-film transistor, constitute a display panel. As shown in FIGS. 13 and 14, the upper face of the lower glass substrate 114 is situated higher than the guide face 106c of the resin frame 106. The lower glass substrate 114 also has a protruding portion 114a that protrudes from the lower deflecting plate 113 and the upper glass substrate 115 toward the concave portions 106d side of the resin frame 106. The upper deflecting plate 103 is disposed on the region corresponding to the display region of the glass substrates 114 and 115.

In the third embodiment, as shown in FIGS. 13, 14, and 18, a light shielding member 116 that is made of a resin material having a light shielding effect such as polycarbonate is fixed to the lower face of the protruding portion 114a of the lower glass substrate 114 via an adhesive layer (not shown). The light shielding member 116 is black and functions as a spacer. The light shielding member 116 is also in contact with the lower deflecting plate 113, and has the same thickness as the lower deflecting plate 113. The light shielding member 116 is also bonded to the diffusion sheet 110 via the adhesive layer 112, as shown in FIGS. 13 through 15. With this arrangement, the protruding portion 114a of the lower glass substrate 114 is supported by the light shielding member 116, and accordingly, the protruding portion 114a of the lower glass substrate 114 can be prevented from breaking on impact. As shown in FIGS. 13 and 14, the light shielding member 116 is provided to cover the upper portion of the side face 108a of the light guide plate 108 through which light from the LEDs 107 enters. As shown in FIG. 14, the light shielding member 116 is disposed so that the light from the LEDs 107 and the light emitted from the LEDs 107 onto the side face 108a of the light guide plate 108 and reflected by the side face 108a of the light guide plate 108 can be shielded from entering a driver IC 117 that will be described later. The light shielding member 116 is also disposed so that the light from the LEDs 107 and the light emitted from the LEDs 107 onto the side face 108a of the light guide plate 108 and reflected by the side face 108a of the light guide plate 108 can be shielded from traveling to the outside via the opening 101a of the upper frame 101.

In the third embodiment, the driver IC 117 for driving the display panel and the panel FPC board 104 are attached onto the upper face of the protruding portion 114a of the lower glass substrate 114. More specifically, the driver IC 117 is disposed in the region on the display panel formed with the glass substrates 114 and 115, other than the region in which the upper deflecting plate 103 is disposed. With this arrangement, the driver IC 117 can be located on the external side of the display region of the glass substrate 114. The driver IC 117 is an example of the “first electronic component” in the claims. The panel FPC board 104 is electrically connected to the driver IC 117. The panel FPC board 104 is also disposed so as to protrude outward from the FPC inserting portion 106b of the resin frame 106 and the notch portion 102d of the lower frame 102.

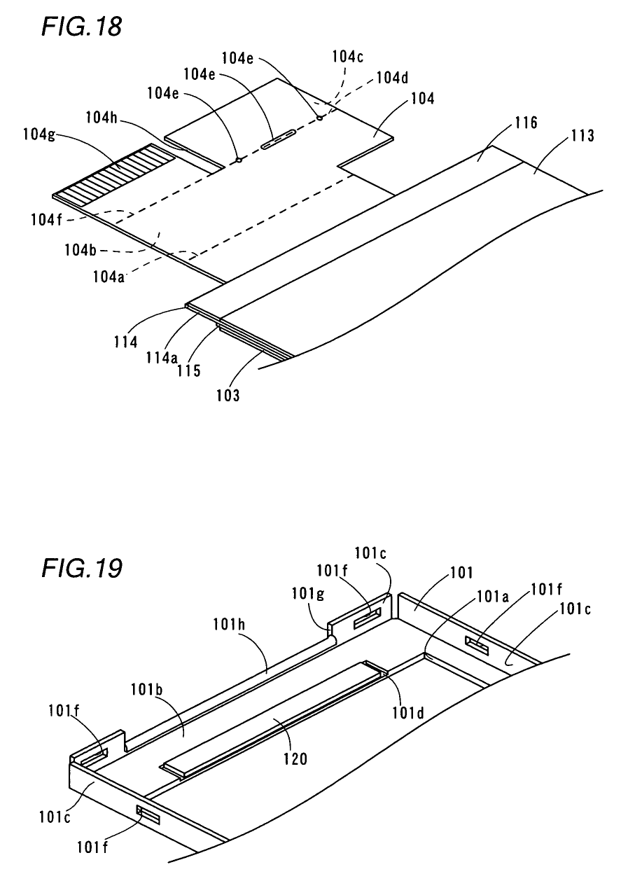

Also in the third embodiment, a bending portion 104a is formed at a portion of the panel FPC board 104 at the side of the glass substrate 114, as shown in FIGS. 15 and 18. The bending portion 104a is an example of the “first bending portion” in the claims. As shown in FIG. 11, electronic component attaching portions 104b and 104c to which electronic components 118 are to be attached are formed outside the bending portion 104a of the panel FPC board 104. The electronic components 118 are an example of the “second electronic components” in the claims, and the electronic components attaching portions 104b and 104c are examples of the “first electronic component attaching portion” and the “second electronic component attaching portion” respectively in the claims. Further, a connector portion 119 to which the connector inserting portion 111a (see FIG. 15) of the backlight FPC board 111 is attached to the electronic component attaching portion 104b of the panel FPC board 104. Also, a bending portion 104d and bending holes 104e (see FIG. 18) are formed between the electronic component attaching portion 104b and the electronic component attaching portion 104c. The bending portion 104d is an example of the “third bending portion” in the claims. The bending holes 104e serve to facilitate the bending of the panel FPC board 104 at the bending portion 104d. Further, a bending portion 104f is formed outside the electronic component attaching portion 104b of the panel FPC board 104. The bending portion 104f is an example of the “second bending portion” in the claims. Each of the bending portions 104a, 104d, and 104f of the panel FPC board 104 is designed to have a smaller thickness than any portion other than the bending portions 104a, 104d, and 104f of the panel FPC board 104. With this arrangement, the panel FPC board 104 can be easily bent at the bending portions 104a, 104d, and 104f. Further, a connector inserting portion 104g is formed outside the bending portion 104f. The connector inserting portion 104g is an example of the “connector inserting portion” in the claims. Also, a slit 104h is formed between the connector inserting portion 104g and the electronic component attaching portion 104c. With the slit 104h, the connector inserting portion 104g and the electronic component attaching portion 104c can be bent independently of each other. In the situation illustrated in FIGS. 11 and 12, the connector inserting portion 104g is connected to a connector portion 131 that is attached onto the printed circuit board 130 of a mobile phone handset.

As shown in FIGS. 13 through 15, the metal upper frame 101 of approximately 0.4 mm in thickness is disposed on the upper deflecting plate 103. The upper frame 101 includes an upper face portion 101b having an opening 101a, and four side face portions 101c that extend downward from the four sides of the upper face portion 101b. The opening 101a of the upper frame 101 is formed in the area corresponding to the display region of the glass substrates 114 and 115.

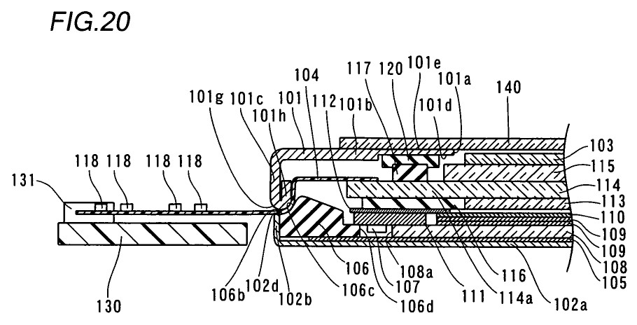

As shown in FIGS. 13, 14, and 19, a facing portion 101d that has a concave shape is formed in the region facing the region of the driver IC 117 under the upper face portion 101b. The facing portion 101d with the concave shape has a smaller thickness (approximately 0.2 mm) than the thickness of the rest of the upper frame 101 (approximately 0.4 mm). The facing portion 101d with the concave shape is formed through a drawing process. The drawing process is carried out using a progressive die at the same time as the process of forming the rest of the upper frame 101. Also, an upper face portion 101e corresponding to the concave facing portion 110d on the lower face of the upper frame 101 has a flat face, as shown in FIGS. 11, 13, and 14. With this arrangement, the upper face portion 101e of the upper frame 101 can be prevented from protruding upward, and accordingly, the upper frame 101 can be prevented from becoming taller. As a result, it becomes easier to attach a device such as a touch panel 140 onto the upper face portion 101e of the upper frame 101, as shown in FIG. 20, and the attachment of the touch panel 140 is not hindered by an increase of the height of the upper frame 101.

As shown in FIGS. 13, 14, and 19, a buffer member 120 that is made of a sponge material having a thickness of approximately 0.2 mm to 0.3 mm is attached onto the facing portion 101d of the upper frame 101 via an adhesive layer (not shown). This buffer member 120 is disposed so that the upper face of the driver IC 117 bites into the lower face of the buffer member 120, with the upper frame 101 being attached to the structure, as shown in FIGS. 13 and 14.

As shown in FIG. 15, the side face portions 101c of the upper frame 1 has insertion holes 101f through which the protruding portions 102c of the lower frame 102 are to be inserted. The side face portions 101c also have a notch portion 101g formed at the location corresponding to the notch portion 102d of the lower frame 102.

As shown in FIGS. 13 and 14, a folding portion 101h is formed inside the notch portion 101g. The folding portion 101h is an example of the “first guide portion” in the claims. In practice, the folding portion 101h is designed to fold back 180 degrees. Accordingly, the bottom portion of the folding portion 101h (or the lower face of the notch portion 101g) has a round shape, and is brought into contact with the panel FPC board 104, so as to prevent the panel FPC board 104 from breaking. The round lower face of the notch portion 101g and the folding portion 101h are arranged so that the panel FPC board 104 is held by the guide face 106c of the resin frame 106. As the panel FPC board 104 can be bent in conformity with the folding portion 101h of the upper frame 101 and the guide face 106c of the resin frame 106, the panel FPC board 104 can extend outside the upper frame 101 and the lower frame 102 from a position lower than the upper face of the glass substrate 114. As a result, when the LCD unit 160 is housed inside a resin upper chassis 150 and a resin lower chassis 151 of a mobile phone handset having an inner face portion protruding downward, a space can be formed between electronic components 118 attached onto the upper face of the panel FPC board 104 and the inner face of the upper chassis 150 of the mobile phone handset, as shown in FIG. 14. Thus, the electronic components 118 cannot be brought into contact with the inner face of the upper chassis 150. By virtue of the provision of the upper chassis 150 and the lower chassis 151 of the mobile phone handset, the FPC board 104 can be guided to a predetermined position by the folding portion 101h and the guide face 106c. Also, since the round-shaped lower face of the notch portion 101g and the folding portion 101h are disposed so that the panel FPC board 104 can be held by the guide face 106c of the resin frame 106, the panel FPC board 104 can be bent in conformity with the folding portion 101h of the upper frame 101 and the guide face 106c of the resin frame 106. Accordingly, the panel FPC board 104 can extend outside the upper frame 101 and the lower frame 102 from a position lower than the upper face of the glass substrate 114. As a result, by virtue of the folding portion 101h of the upper frame 101 and the guide face 106c of the resin frame 106, the panel FPC board 104 can be folded and guided into the space that is formed by an inner face portion of the upper chassis 150 and an inner face portion of the lower chassis 151.

As described above, in the third embodiment, the light shielding member 116 is provided to prevent the light of the LEDs 107 from entering the driver IC 117 whereby the light from the LED 107 can be prevented from entering the driver IC 117. Accordingly, an error is not caused by the light emitted from the LEDs 107. Also, since the driver IC 117 is attached onto the glass substrate 114, the panel FPC board 104 can be made smaller than in a case where the driver IC 117 is attached onto the panel FPC board 104.

Also in the third embodiment, the light shielding member 116 that is designed to function as a spacer is disposed on the lower face side of the protruding portion 114a of the glass substrate 114, onto which the driver IC 117 is also disposed. With this arrangement, the protruding portion 114a of the glass substrate 114, onto which the driver IC 117 is disposed, can be supported by the light shielding member 116. Thus, the protruding portion 114a of the glass substrate 114, onto which the driver IC 117 is disposed, can be prevented from breaking on impact.

Also in the third embodiment, the light shielding member 116 that functions as a spacer is adjacent to the lower deflecting plate 113 between the protruding portion 114a of the glass substrate 114 and the LEDs 107, and has substantially the same thickness as the lower deflecting plate 113. With this arrangement, the light shielding member 116 having substantially the same thickness as the lower deflecting plate 113 can be easily caused to function as a spacer between the protruding portion 114a of the glass substrate 114 and the LEDs 107.

Also in the third embodiment, the light shielding member 116 is provided to cover the upper portion of the side face 108a of the light guide plate 108, so that the light reflected by the side face 108a of the light guide plate 108 can be prevented from entering the driver IC 117. Thus, the driver IC 117 can be easily prevented from wrongly operating due to the light reflected by the side face 108a of the light guide plate 108.

Also in the third embodiment, the light shielding member 116 is provided to prevent the light of the LEDs 107 from traveling outward via the opening 101a of the upper frame 101. By virtue of the provision of the light shielding member 116, the light emitted from the LEDs 107 can be prevented from traveling outward via the opening 101a of the upper frame 101.

Also in the third embodiment, the light shielding member 116 is made of a resin material with a light shielding effect, so that the hardness of the light shielding member 116 can be made lower than the hardness of the glass substrate 114. Accordingly, even when the light shielding member 116 is brought into contact with the glass substrate 114 due to impact or vibration, the glass substrate 114 cannot be damaged by the light shielding member 116.

Also in the third embodiment, the light shielding member 116 is attached via the adhesive layer 112, so that the light shielding member 116 is prevented from moving. Accordingly, the light shielding member 116 can be held in an effective light shielding position.

It should be understood that the above described embodiments are merely examples, and the present invention is not limited to them. The scope of the present invention is shown in the claims, not in the above described embodiments. Therefore, various changes and modification may be made to the embodiments within the scope of the claimed invention.

For example, although the present invention is applied to a LCD unit as an example of a display in each of the first through third embodiments, it may be applied to any other type of display, such as an organic EL display, as long as the display has a display panel.

Although the number of LEDs is four in each of the first through third embodiments, it is not limited to that. The number of LEDs may be less than four, or five or more. However, it is preferable to employ two or more LEDs.

Although the light leakage preventing portions are disposed at four locations in the first embodiment, the present invention is not limited to that structure. The light leakage preventing portions may be disposed at three or less locations, or five or more locations. The number of light leakage preventing portions should preferably be the same as the number of positioning portions of the lens sheets and the number of concave portions of the resin frame.

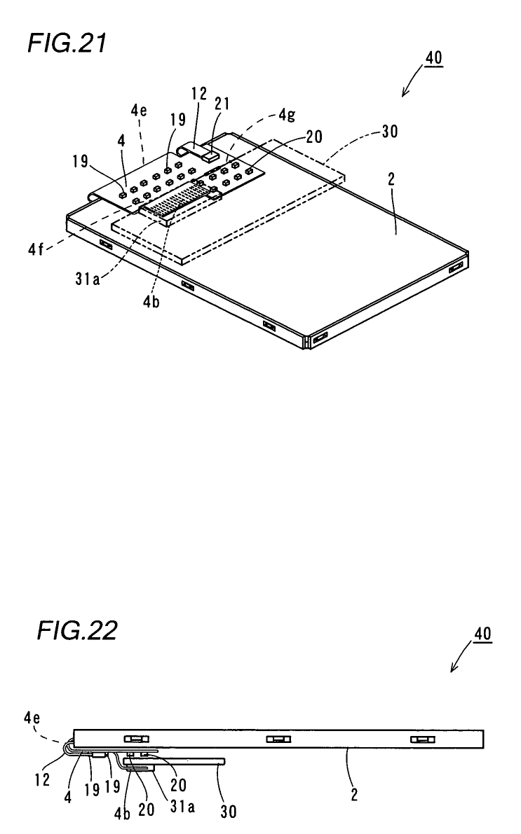

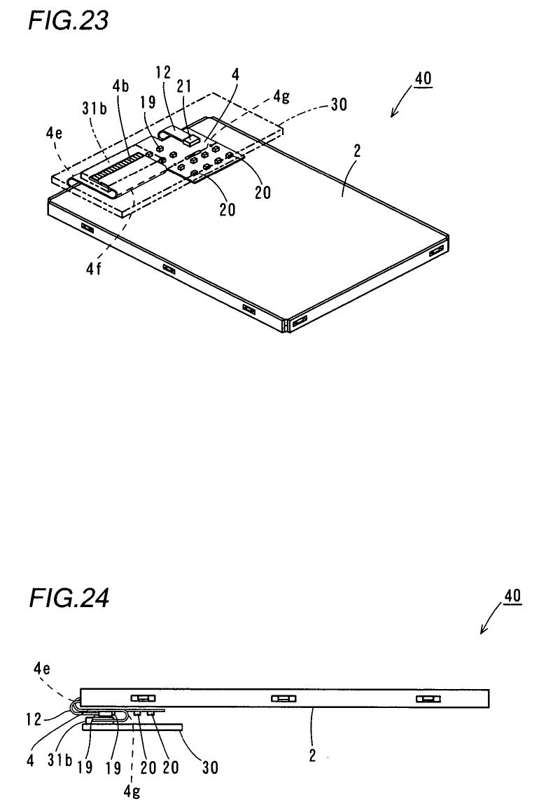

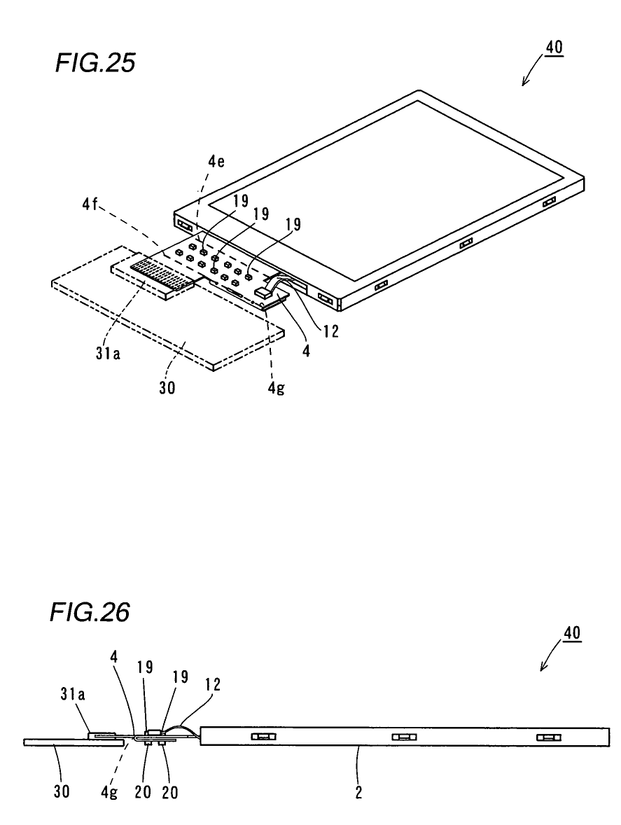

Although the bending portions 4e, 4f, and 4g of the panel FPC board 4 (the bending portions 104a, 104d, and 104f of the panel FPC board 104) are shown as not being bent in the first embodiment (the third embodiment), the present invention is not limited to that structure. FIGS. 21 through 26 illustrate first through third modifications of the present invention. As in the first modification illustrated in FIGS. 21 and 22, the bending portion 4e of the panel FPC board 4 of the LCD unit 40 may be bent, and the connector inserting portion 4b of the panel FPC board 4 extending in the bending direction may be connected to the connector portion 31a of the printed circuit board 30 of a mobile phone handset. In this case, the panel FPC board 4 of the LCD unit 40 may be disposed below the lower frame 2 of the LCD unit 40. As in the second modification illustrated in FIGS. 23 and 24, the bending portions 4e and 4f of the panel FPC board 4 of the LCD unit 40 are bent, but the bending portion 4g (see FIG. 23) of the panel FPC board 4 may not be bent. In this structure, the panel FPC board 4 can be inserted to a connector portion 31b opposed to the connector portion 31a of the printed circuit board 30 of the mobile phone handset shown in FIGS. 21 and 22. As in the third modification illustrated in FIGS. 25 and 26, the bonding portions 4e and 4f (see FIG. 25) of the panel FPC board 4 of the LCD unit 40 are not bent, but the bending portion 4g may be bent. In this structure, the electronic components 19 and 20 can be disposed on and under the panel FPC board 4 of the LCD unit 40. Also, as the bending portion 4g of the panel FPC board 4 of the LCD unit 40 is bent, so that the electronic component attaching portion 4c is disposed below the electronic component attaching portion 4a. Accordingly, the electronic component attaching portion 4c does not overlap the upper portion of the printed circuit board 30 of the mobile phone handset. Thus, the area that can serve as the circuit region of the printed circuit board 30 of the mobile phone handset can be increased.

Also in the third embodiment, the light shielding member 116 is designed to function as a spacer. However, the present invention is not limited to that structure, and the light shielding member 116 may not function as a spacer.

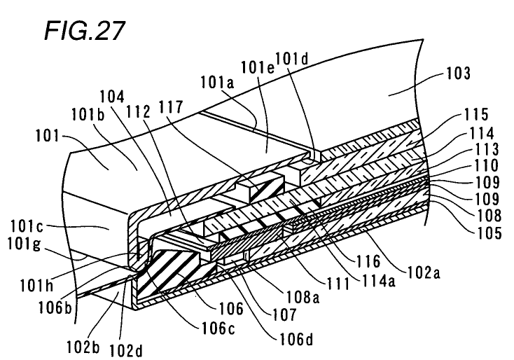

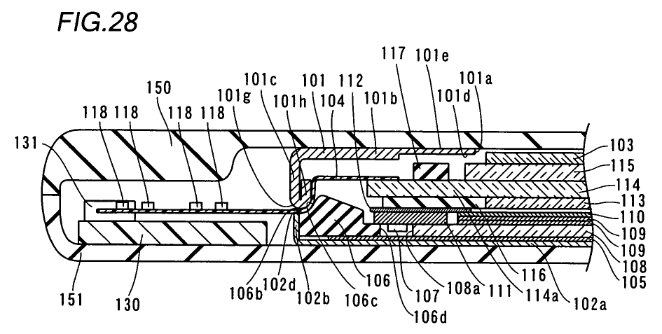

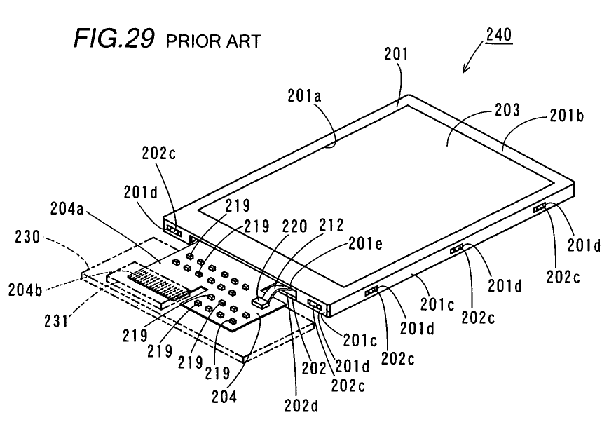

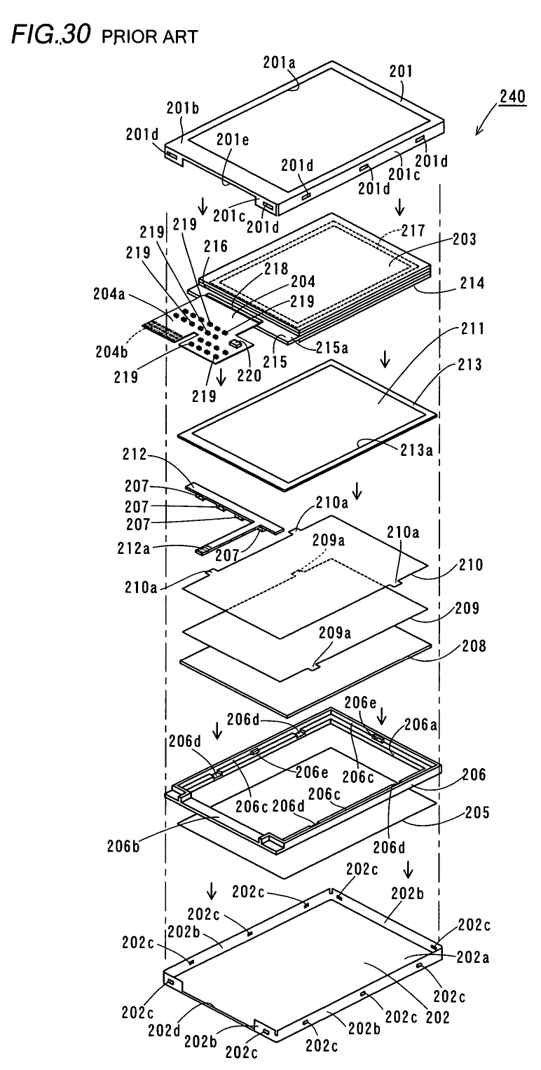

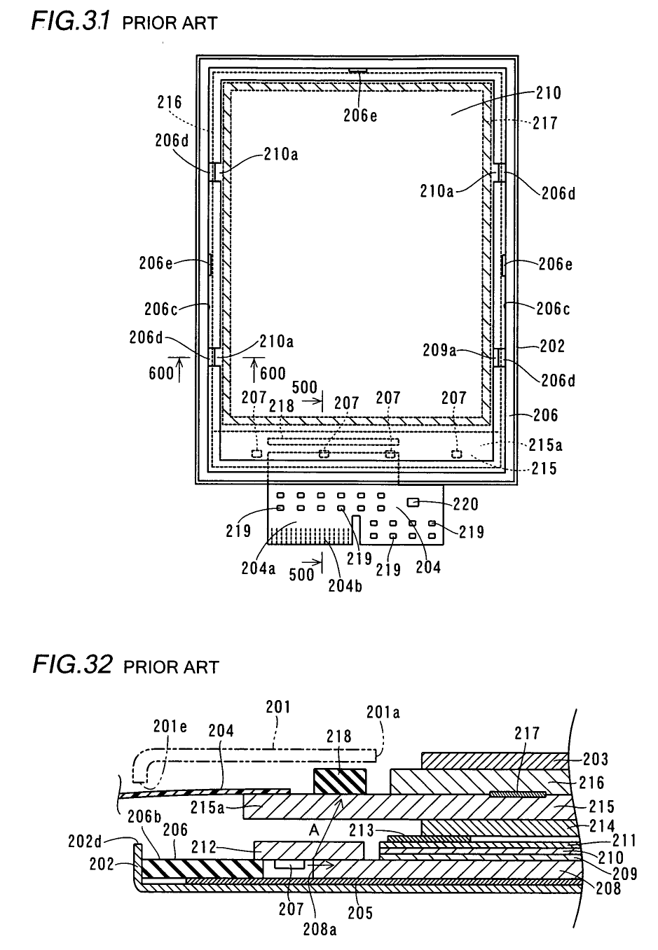

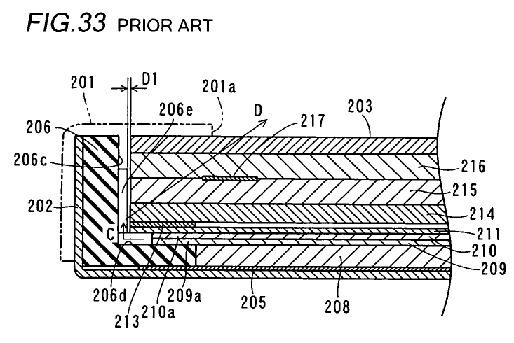

Although the buffer member 120 is interposed between the driver IC and the facing portion of the upper frame in the third embodiment, the present invention is not limited to that structure. As in a fourth modification illustrated in FIGS. 27 and 28, a buffer member may not be interposed between the driver IC 117 and the facing portion 101d of the upper frame 101. In this structure, the facing portion 101d having a concave shape of the upper frame 101 widens the distance between the driver IC 117 and the facing portion 101d of the upper frame 101. Accordingly, the driver IC 117 cannot be brought into contact with the facing portion 101d of the upper frame 101 due to impact or vibration. Thus, the driver IC 117 can be prevented from breaking, and defective display due to damage to the driver IC 117 can be prevented.

Although the upper face of the driver IC 117 is designed to bite into the lower face of the buffer member 120 in the third embodiment, the present invention is not limited to that structure. The upper face of the driver IC may not bite into the lower face of the buffer member.

What is claimed is:

1. A display comprising:
a display panel that has a display region;
a frame that houses said display panel;
a backlight source that is disposed on the back face side of said display panel; and
a light shielding portion that is disposed on said display panel and covers the regions other than said display region of said display panel, wherein
said light shielding portion comprises a light leakage preventing portion that is designed to partially protrude toward a side end face of said display panel when viewed from the top, and preventing light leakage from said backlight source.

2. The display as claimed in claim 1, wherein:
said frame comprises a concave portion or a convex portion for positioning; and
said light leakage preventing portion of said light shielding portion is disposed at the location corresponding to the concave portion or the convex portion of said frame, so as to prevent light leakage from said backlight source due to the concave portion or the convex portion of said frame.

3. The display as claimed in claim 2, further comprising a lens sheet that supplies light from said backlight source to said display panel,
wherein:
a positioning portion that is a convexity when viewed from the top is disposed on a side end face of said lens sheet;
said concave portion for positioning the convex positioning portion of said lens sheet is formed on said frame; and
said light leakage preventing portion of said light shielding portion is disposed at the location corresponding to the concave portion of said frame.

4. The display as claimed in claim 3, wherein said light leakage preventing portion of said light shielding portion has a greater width than the width of the concave portion of said frame.

5. The display as claimed in claim 2, wherein:
said convex portion for positioning a side end face of said display panel is disposed on said frame; and
said light leakage preventing portion of said light shielding portion is disposed at the location corresponding to the convex portion of said frame.

6. The display as claimed in claim 5, wherein said light leakage preventing portion of said light shielding portion has a greater width than the width of the convex portion of said frame.

7. The display as claimed in claim 1, wherein said light leakage preventing portion of said light shielding portion is designed not to reach a side end face of said display panel, but to extend to a point where a predetermined distance is kept from the side end face of said display panel.

8. The display as claimed in claim 1, wherein:
said display panel comprises a glass substrate; and
said light leakage preventing portion of said light shielding portion is disposed on the glass substrate in such a manner as to cover said glass substrate, except for the display region.

9. The display as claimed in claim 1, further comprising a flexible printed circuit board for said display panel that is attached to said display panel and is designed to extend outward from the inside of said frame,
wherein said flexible printed circuit board comprises a connector inserting portion, a first bending portion that is located on the side of said display panel, and a second bending portion that is located between said connector inserting portion and said first bending portion.

10. The display as claimed in claim 9, wherein:
a first electronic component and a second electronic component are mounted to said flexible printed circuit board; and
said flexible printed circuit board comprises a first electronic component attaching portion to which said first electronic component is attached, a second electronic component attaching portion to which said second electronic component is attached, and a third bending portion that is located between said first electronic component attaching portion and said second electronic component attaching portion.

11. The display as claimed in claim 10, wherein said flexible printed circuit board has a slit formed between said connector inserting portion and said second electronic component attaching portion.

12. A mobile device comprising a display that comprises:
a display panel that has a display region;
a frame that houses said display panel;
a backlight source that is disposed on the back face side of said display panel; and
a light shielding portion that is disposed on said display panel and covers the regions other than said display region of said display panel, wherein
said light shielding portion comprises a light leakage preventing portion that is designed to partially protrude toward a side end face of said display panel when viewed from the top, and preventing light leakage from said backlight source.

13. A display comprising:
a display panel;
a first electronic component that is attached to said display panel;
a backlight source that is disposed on a back face of said display panel; and
a light shielding member that is provided to prevent light of said backlight source from entering said first electronic component.

14. The display as claimed in claim 13, wherein:
said light shielding member is disposed between said backlight source and a lower face of a region of said display panel to which said first electronic component is attached; and
said light shielding member is designed to function as a spacer.

15. The display as claimed in claim 13, wherein:
said display panel includes an upper glass substrate and a lower glass substrate;
said lower glass substrate protrudes toward a side in relation to the upper glass substrate, and includes a protruding portion having an upper face to which said first electronic component is attached; and
said light shielding member is disposed between said protruding portion of said lower glass substrate and said backlight source, and is designed to function as a spacer.

16. The display as claimed in claim 15, further comprising a deflecting plate that is disposed below said lower glass substrate,
wherein said light shielding member designed to function as a spacer is disposed between said protruding portion of said lower glass substrate and said backlight source so as to be adjacent to said deflecting plate, and has substantially the same thickness as said deflecting plate.

17. The display as claimed in claim 13, further comprising a light guide plate that is designed to horizontally face said backlight source, and has a side face through which the light from said backlight source enters,
wherein said light shielding member is provided to prevent light reflected by a side face of said light guide plate from entering said first electronic component.

18. The display as claimed in claim 17, wherein said light shielding member is provided to cover at least an upper portion of the side face of said light guide plate through which the light from said backlight source enters.

19. The display as claimed in claim 13, wherein:
said display panel has a display region;
said display further comprises a frame that houses said display panel and has an opening at the location corresponding to said display region of said display panel; and
said light shielding member is provided to prevent the light of said backlight source from traveling outward through the opening of said frame.

20. The display as claimed in claim 13, wherein said light shielding member is made of a resin material having a light shielding effect.

21. The display as claimed in claim 13, wherein said light shielding member is fixed to a lower face of said display panel above the region in which said backlight source is disposed.

22. The display as claimed in claim 13, further comprising a flexible printed circuit board that is attached to said display panel and is electrically connected to said first electronic component,
wherein said flexible printed circuit board comprises:
a connector inserting portion; a first bending portion that is disposed on a side of said display panel; and a second bending portion that is interposed between said connector inserting portion and said first bending portion.

23. The display as claimed in claim 22, wherein said flexible printed circuit board further comprises: a first electronic component attaching portion and a second electronic component attaching portion to which a second electronic component is attached; and a third bending portion that is formed between said first electronic component attaching portion and said second electronic component attaching portion.

24. The display as claimed in claim 23, wherein said flexible printed circuit board further comprises a slit that is formed between said connector inserting portion and said second electronic component attaching portion.

25. The display as claimed in claim 23, further comprising a frame that houses said display panel,
wherein:
said frame comprises a first guide portion and a second guide portion that guides said flexible printed circuit board to the outside of said frame;
said first guide portion is in contact with an upper face of said flexible printed circuit board; and
said second guide portion is in contact with a lower face of said flexible printed circuit board.

26. A mobile device comprising
a display that comprises:
a display panel;
a first electronic component that is attached to said display panel;
a backlight source that is disposed on a back face side of said display panel; and
a light shielding member that is provided to prevent light of said backlight source from entering said first electronic component.
